(19) United States
(12) Patent Application Publication
(10) Pub. No.: US 2006/0088720 A1
(43) Pub. Date: Apr. 27, 2006

(54) Coated packaging materials

(76) Inventors: Ken W. Niederst, Allison Park, PA (US); Lawrence J. Fitzgerald, Gibsonia, PA (US)

Correspondence Address: PPG Industries, Inc.;Intellectual Property Department, One PPG Place, Pittsburgh, PA, 15272, US

(21) Appl. No.: 10/972,129

(22) Filed: Oct. 22, 2004

(51) Int. Cl. B32B 27/00; B05D 3/02; B05D 1/36

(52) U.S. Cl. 428/500; 428/522; 427/372.2; 427/402

(57) ABSTRACT

Packaging material coated with a thermally curable coating comprising one or more thermally curable groups and one or more radiation curable groups is disclosed. Packaging material having a second layer comprising a radiation curable colorant is also disclosed.

### FIELD OF THE INVENTION

The present invention relates to coated packaging materials.

### BACKGROUND INFORMATION

It is typically desired that packaging materials contain one or more layers for decorative and/or protective purposes. For example, packaging material often includes the name of the product, nutritional information, decorative pictures and the like. Such decoration can be imparted to the packaging material, for example, by use of an ink. Adhesion of the ink to the packaging material can be problematic, however. Improved adhesion of ink to packaging materials is therefore desired.

Packaging material also often includes one or more protective layers, such as coating layers that impart gas barrier properties. Many plastics used as packaging material tend to be gas permeable. It is therefore also often desired to provide protection from gas permeability to packaging materials.

### SUMMARY OF THE INVENTION

The present invention is directed to packaging material comprising at least one coating layer having one or more thermally curable groups and one or more radiation curable groups. The radiation curable moieties that contain ethylenic unsaturation can serve as a gas barrier for the packaging material, since oxygen can add across the double bond. The present invention is also directed to the packaging material comprising a first coating comprising one or more thermally curable groups and one or more radiation curable groups and a second coating layer comprising a radiation curable colorant. In these embodiments, enhanced adhesion is believed to result from cross-curing of the radiation curable groups in the first coating with the coating comprising the radiation curable colorant, although the inventors do not wish to be bound by any mechanism.

### DETAILED DESCRIPTION OF THE INVENTION

The present invention is directed to packaging material comprising a thermally curable coating comprising one or more thermally curable groups and one or more radiation curable groups. In certain nonlimiting embodiments, this coating comprises a film-forming resin to which is attached one or more thermally curable group(s) and one or more radiation curable group(s). In other nonlimiting embodiments, the thermally curable group(s) and radiation curable group(s) are not attached to the same resin. The weight percent of radiation curable group(s) in this coating is below that which is needed to render it radiation curable. This coating is sometimes referred to herein as the first coating.

The first coating can be either a one-componentor “1K” system or a two-component or “2K” system. For the 1K system, the thermally curable group(s) can be self-curing, such as at ambient or elevated temperatures, or can cure in the presence of a curing agent at ambient or elevated temperatures. For 2K systems, the curing agent or agents (“curing agent pack”) are kept separate from the reactive thermally curable group(s) (“resin pack”); the packs are combined shortly before application. Following mixture of the resin pack with the curing agent pack, and application of the resulting mixture on the substrate, the substrate can then optionally be treated such as at ambient or elevated temperatures to facilitate cure of the curing agent(s) with the thermally curable group(s).

As noted above, in certain nonlimiting embodiment the thermally curable group(s) and the radiation-curable group(s) are on the same film-forming resin, sometimes referred to herein as the “first film-forming resin”. Any film-forming resin having one or more thermally curable functional groups can be used according to the present invention. According to certain embodiments of the present invention, this resin either has or can be modified to have a radiation curable group or groups attached thereto. According to other embodiments of the present invention, the thermally curable group(s) can be on one resin and the radiation curable group(s) on another resin. As used herein, the term “thermally curable” and variants thereof refer to coatings and/or groups that can be cured or crosslinked at ambient or elevated temperatures and not by actinic radiation. Examples of polymers having thermally curable groups include hydroxyl or carboxylic acid-containing acrylic copolymers, hydroxyl or carboxylic acid-containing polyester polymers, isocyanate or hydroxyl containing polyurethane polymers, and amine or isocyanate containing polyureas. These polymers are further described in U.S. Pat. No. 5,939,491, column 7, line 7 to column 8, line 2; this patent, as well as the patents referenced therein, are incorporated by reference herein. Curing agents for these resins are also described in the '491 patent at column 6, lines 6 to 62. Combinations of curing agents can be used. Particularly suitable is a resin comprising isocyanate groups and a curing agent comprising hydroxy groups, or vice versa.

In certain nonlimiting embodiments, the first coating comprises, in addition to the first film-forming resin, a second film-forming resin. Any film-forming resin having one or more thermally curable functional groups can be used as the second film-forming resin according to the present invention, including those discussed above. The first and second film-forming resins can be the same, except for the radiation curable group(s) being present on the first but not the second film-forming resin. The first and second film-forming resins can be different in ways other than the presence of the radiation curable group(s); for example, the resin backbone can be the same or different and/or the thermally curable group(s) on each of the resins can be the same or different. An appropriate curing agent or agents can be selected by one skilled in the art, depending on the thermally curable group(s) on the film-forming resin(s). If the thermally curable group(s) on each of the film-forming resins are the same, one curing agent may be sufficient, but if the thermally curable group(s) on each of the film-forming resins are different, two or more curing agents may be used. There is no limit to the number of curing agents used according to the present invention. Similarly, there is no limit to the number of film-forming resins used according to the present invention; use of one or two film-forming resins reflects just certain embodiments.

As noted above, in certain embodiments, the first film-forming resin contains or is “modified” to contain radiation curable group(s). In other embodiments, the thermally curable group(s) and radiation curable group(s) are on different resins. As used herein, the term “radiation curable group(s)” refers to any functional group that can react such as via an addition reaction, upon exposure to actinic radiation, such as UV radiation or electron beam radiation. Examples of such groups include but are not limited to acrylates, methacrylates, vinyl ethers, ethylenically unsaturated resins, maleic unsaturated polyesters, fumarates, thiols, alkenes, epoxies and the like. “(Meth)acrylate” and like terms are used herein to refer to both acrylate and methacrylate. “Modified” and like terms refer to the covalent bonding of the radiation curable group(s) to the resin. Thus, in certain nonlimiting embodiments the radiation curable group(s) are physically attached to the resin, while in other nonlimiting embodiments the radiation curable group(s) and the thermally curable group(s) are not physically attached to the same resin. It will be understood that in those embodiments where the radiation curable group(s) are covalently bonded to the resin, bonding is achieved such that the radiation curable group(s) are still reactive upon exposure to radiation.

The first coating of the present invention comprises radiation curable group(s) in a weight percent below that which is needed to render the coating radiation curable. The appropriate amount of radiation curable groups in the first coating can be determined by one skilled in the art. In certain embodiments, the amount of carbon-carbon double bonds on the resin is seven percent or less; that is, seven percent or less of the total weight of the coating, based on solids is carbon-carbon double bonds.

It will be appreciated that “dual cure” resins, comprising both thermally curable group(s) and radiation curable group(s), are known in the art. These resins, as the name implies, undergo two different types of cure. One cure mechanism is a thermal cure, such as through use of a curing agent and/or the application of heat; the second cure mechanism is through exposure to actinic radiation. The result of the dual cure is the formation of two interpenetrating networks, one of which is based on the thermally cured group(s) and the other of which is based on the radiation curable group(s). The weight percent of radiation curable group(s) used in the first coating according to the present invention is not high enough to render the first coating dual cure; the first coating is only thermally curable. Thus, if the first coating was exposed to actinic radiation, it would not cure; “cure” as used in reference to a coating refers to a reaction between the components such that they resist melting upon heating. Thus, the reaction between radiation curable group(s) in the first coating that might occur in isolated spots upon exposure to actinic radiation would not be sufficient to impart melt resistance to the coating upon heating. Rather, the first film-forming resin cures by crosslinking of the thermally curable group(s).

The first film-forming resins comprising one or more thermally curable group(s) and one or more radiation curable group(s) can be prepared by reacting a first material and a second material. The first material may contain at least one radiation curable group and at least one nonradiation curable group capable of reaction with the second material. The second material may contain at least one functional group capable of reacting with the non-radiation curable group on the first material. One nonlimiting embodiment includes the reaction of a hydroxy functional acrylate with a polyisocyanate, resulting in a resin-containing isocyanate functionality and acrylate functionality on the same molecule. An acrylate functional isocyanate is also commercially available from Bayer in their ROSKYDAL line. Alternatively, resin(s) comprising thermally curable group(s) and resin(s) comprising radiation curable group(s) can be mixed together.

In certain nonlimiting:embodiments of the present invention, the first film-forming resin comprises at least one isocyanate having one or more ethylenically unsaturated moieties and one or more isocyanate (“NCO”) groups. The NCO group(s) can be free or blocked. In these embodiments, the first film-forming resin will typically be in a first or resin pack, and a curative for the isocyanate will typically be in a curing agent pack, with the two packs being mixed just prior to application. Examples of ethylenically unsaturated isocyanates include (meth)acryloxy isocyanate. In other nonlimiting embodiments, the resin comprises hydroxy groups and radiation curable groups and the coating comprises isocyanate. In other embodiments the two components can comprise polyepoxides and carboxylic acid acrylates; anhydrides and hydroxyacrylates; or aminoplasts and hydroxyacrylates.

The first coating, in addition to the one or more film-forming resins described above, can further comprise pigments, fillers, rheology modifiers, surface active agents, light stabilizers, catalysts, oxygen scavengers, oxygen scavenging accelerators and other additives known to those skilled in the art, which are used to achieve specific end use performance properties. Additional resinous materials may also be present such as crosslinkers and film-forming resins different from the film-forming resins described above. Solvents and diluents may also be used. The film-forming resin(s) generally comprises 5 to 95 weight percent, such as 25 to 60 weight percent of the first coating. Curing agent(s), if used, typically comprise 5 to 95 weight percent, such as 25 to 75 weight percent of the first coating. Other ingredients in the first coating, if used, are typically present in an amount of up to 50 weight percent of the first coating. All of these weight percents are solid weight percentages of the total solid weight of the coating.

The present invention is further directed to packaging material comprising a first coating comprising one or more thermally curable groups and one or more radiation curable groups, and a second coating comprising a radiation curable colorant. As used herein, the term “radiation curable colorant” and like terms refer to any color-imparting compound that can be cured by actinic radiation such as UV curable ink and the like. A “colorant” can include, for example, inks, dyes and/or pigments and the like. Such products are commercially available, for example, from Sun Chemical Corporation, Fort Lee, N.J. Actinic radiation includes, but is not limited to, UV radiation, electron beam radiation, and even visible light curing, depending on the initiator(s) used.

The second coating may also contain other additives such as one or more initiators, such as photoinitiators, dispersants, dispersion vehicles, accelerators and other standard additives.

The present invention is further directed to a method for coating a packaging material as described above. The coatings described herein, as well as other coatings known in the art, can be applied to at least a portion of the packaging material, and can be applied to the packaging material directly or over at least a portion of a preexisting coating layer. Certain embodiments generally comprise applying a first coating to a packaging material. The first coating, as described above, comprises both thermally curable group(s) and radiation curable group(s) in a weight percent below that which is needed to render the coating radiation curable. The coating is formulated and mixed by means known to those skilled in the art, and can be applied to the substrate through any manner known in the art, such as spray coating, roll coating, brushing dipping, casting/spin coating, electrostatic coating, flow coating and the like. Following application of the first coat, the substrate is subjected to a thermal cure. Thermal cure can occur at ambient or elevated temperatures. Thermal cure is affected so as to react the majority of the thermally curable groups with the curing agent(s). While the majority of the thermally curable groups will react, it is recognized in the art that some of the thermally curable groups may not react completely upon exposure to the cure conditions, but may continue to react slowly over time (i.e. “post-cure”); it is further recognized that it is unlikely that 100% of the groups will undergo reaction. The term “fully cured” as used herein therefore does not mean that 100% of the groups have cured, but rather a majority as described above.

In certain nonlimiting embodiments, following completion of the thermal cure step, a second coating comprising a radiation curable colorant is applied to the packaging material so as to be at least partially in contact with the first coating. The second coating is as described above, and can also be applied using any suitable means. In certain nonlimiting embodiments, it will be desired to apply the second coating in a predetermined pattern or design. Following application of the second coating, the packaging material is subjected to actinic radiation for a time sufficient to effect cure of the radiation curable colorant. One skilled in the art can determine the appropriate dose, irradiance, actinic radiation source and the like, to effect cure, depending on the colorant(s) selected.

While affecting cure of the radiation curable colorant of the second coating, the exposure to actinic radiation will also cause the radiation curable groups in the first coating to react with and bond to radiation curable group(s) in the second coating. Intercoat adhesion between the first coating and second coating is believed to result from this cross-curing of the radiation curable groups in each of the layers. In those embodiments in which the radiation curable group(s) in the first coating are physically attached to the same resin as the thermally curable group(s), intercoat adhesion is believed to be even greater; the cross-cured radiation groups are physically attached to the cured first coating, and therefore are believed to be more durable than if, for example, the radiation curable groups were simply mixed with a thermally curable resin. It will be appreciated that in certain embodiments some but not all of the radiation curable group(s) in the first coating may react and cross-cure with the second coating while others remain unreacted. In these embodiments, both improved adhesion and gas barrier may be observed.

The first coating can be deposited and cured and the second coating deposited and cured, or the second coating can be deposited on an uncured or partially cured first coating and the two layers can be cured concurrently or sequentially with either actinic radiation followed by thermal cure or vice versa. In certain nonlimiting embodiments, the second coating can be deposited first and the thermally curable layer having radiation curable moieties deposited on at least a portion of the uncured or partially cured second coating. The two layers can then be cured concurrently or sequentially with either the actinic radiation followed by thermal cure or vice versa. In these embodiments, the thermally curable layer will be either unpigmented or lightly pigmented. “Lightly pigmented” and similar terms refer to pigmented systems in which actinic radiation can still penetrate; such systems can contain, for example, pigments that are relatively light in color or that contain relatively small concentrations of pigment. Regardless of the order of application of coatings and cure, the thermally curable layer will have the majority of the thermal groups reacted in certain embodiments.

The multilayer coating system of the present invention can be applied to a variety of substrates and used in a variety of applications. “Packaging material” and like terms refers to any material suitable for creating a package including but not limited to Mylar, metallic foil, stretch wrap, cellophane, metal, glass, and polymers having gas permeability, including but not limited to polyesters, polyolefins, polyamides, cellulosics, polystyrenes, polyacrylics, polycarbonates, polyethylene terephthalate, poly(ethylene naphthalate) and any combinations thereof.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Also, as used herein, the term “polymer” is meant to refer to prepolymers, oligomers and both homopolymers and copolymers; the prefix “poly” refers to two or more.

### EXAMPLES

The following examples are intended to illustrate the invention, and should not be construed as limiting the invention in any way.

### Example 1

Clear Coat: Polyol Package

| COMPONENT | QUANTITY/POUNDS |
|---|---|
| Diisobutyl ketone | 154.611 |
| Methyl isobutyl ketone | 254.116 |
| Optical brightener¹ | 1.674 |
| Cellulose acetate butyrate² | 10.087 |

Must mix well to dissolve the CAB at this point before continuing.

| | |
|---|---|
| TINUVIN 328³ | 9.367 |

Must mix well to dissolve the TINUVIN 328 at this point
before continuing.

| | |
|---|---|
| HRB 4856 Polyol⁴ | 292.470 |
| TERATHANE 1000⁵ | 30.610 |
| TOTAL | 752.935 |

¹RC-B Thiopene, from Wujin Fine Chemicals or Q-OB from NY Fine Chemicals.
²CAB 551.0.2 PM3024 from Eastman Chemical.
³Benzotriazole UV absorber from Ciba Additives.
⁴Polyester-urethane polyol available from PPG Industries, Inc.
⁵Polyether polyol available from DuPont.

### Example 2

Clear Coat at High Solids: Polyol Package

| COMPONENT | QUANTITY/POUNDS |
|---|---|
| Diisobutyl ketone | 146.13 |
| Methyl isobutyl ketone | 224.99 |
| Optical brightener | 1.80 |
| Cellulose acetate butyrate | 10.87 |

Must mix well to dissolve the CAB at this point before continuing.

| | |
|---|---|
| TINUVIN 328 | 10.09 |

Must mix well to dissolve the TINUVIN 328 at this point
before continuing.

| | |
|---|---|
| HRB 4856 Polyol | 315.12 |
| TERATHANE 1000 | 32.98 |
| Methyl isobutyl ketone | 17.32 |
| TOTAL | 759.30 |

### Example 3

Either of the polyol coatings can be mixed with a resin comprising both thermally curable groups and radiation curable groups, such as an adduct of 2016 parts DESMODUR N 3300 (polyisocyanate crosslinker available from Bayer Corporation) and 106.1 parts Hydroxyethylacrylate; solid NCO equivalent weight=192; thinned to 60% solids in methyl isobutyl ketone. The mixture can be applied to packaging material, such as aluminum can stock, using an appropriate draw bar or wire wound bar. The coatings can be cured for 10 minutes at 200° F. in a lab convection oven to a dry film thickness of about 0.5 mils. If desired, cobalt octoate can be added to either of the coatings prior to application to the packaging material in an amount of 100 to 1000 ppm cobalt (as Co⁺⁺). A decorative layer comprising a radiation curable colorant, such as EJ-81-505K, a blue UV curable ink available from PPG Industries, Inc., can then be applied using appropriate means, such as an appropriate draw down bar or wire wound bar to partially or fully cover the first coating. Application can be, for example, according to a predetermined design or pattern. The ink can then be cured at an appropriate dose, such as from 100 to 2000 millijoules/cm². Good adhesion between the first layer and the ink would be expected.

Whereas particular embodiments of this invention have been described above for purposes of illustration, it will be evident to those skilled in the art that numerous variations of the details of the present invention may be made without departing from the invention as defined in the appended claims.

Therefore, what is claimed is:

1. Packaging material comprising:
a coating comprising one or more thermally curable groups and one or more radiation curable groups.

2. The packaging material of claim 1, wherein the thermally curable group(s) comprise hydroxy groups.

3. The packaging material of claim 1, wherein the thermally curable group(s) comprise isocyanate groups.

4. The packaging material of claim 1, wherein the first coating comprises at least one isocyanate having one or more ethylenically unsaturated moieties and one or more isocyanate groups.

5. The packaging material of claim 1, wherein the radiation curable group(s) comprise (meth)acrylate functionality.

6. Packaging material comprising:
(a) a first coating comprising one or more thermally curable groups and one or more radiation curable groups; and
(b) a second coating comprising a radiation curable colorant.

7. The packaging material of claim 6, wherein the thermally curable group(s) comprise hydroxy groups.

8. The packaging material of claim 6, wherein the thermally curable group(s) comprise isocyanate groups.

9. The packaging material of claim 6, wherein the first coating comprises at least one isocyanate having one or more ethylenically unsaturated moieties and one or more isocyanate groups.

10. The packaging material of claim 6, wherein the radiation curable group(s) comprise (meth)acrylate functionality.

11. The packaging material of claim 1, wherein the weight percent of radiation curable group(s) is seven or less, based upon the total solids weight of the coating.

12. The packaging material of claim 6, wherein the weight percent of radiation curable group(s) is seven or less, based upon the total solids weight of the first coating.

13. The packaging material of claim 1, wherein the coating further comprises cobalt octoate.

14. The packaging material of claim 6, wherein the first coating further comprises cobalt octoate.

15. A method for coating packaging material comprising:
(a) applying to the packaging material the coating of claim 1; and
(b) curing the coating.

16. The method of claim 15, further comprising:
(c) applying a second coating comprising a radiation curable colorant; and
(d) curing the second coating.

17. A method for coating packaging material comprising:
(a) applying to the packaging material a coating comprising one or more thermally curable groups and one or more radiation curable groups;
(b) applying to the packaging material a coating comprising one or more radiation curable colorants;
wherein either step (a) or step (b) is done first, but when step (b) is done first the coating comprising the thermally curable group(s) and radiation curable group(s) is not pigmented or is lightly pigmented.

18. The method of claim 17, wherein the first applied layer is fully cured before application of the second layer.
